(19) United States
(12) Patent Application Publication
(10) Pub. No.: US 2006/0091158 A1
(43) Pub. Date: May 4, 2006

(54) High-barrier plastic caulk cartridge and method of making same

(75) Inventors: Howard Coker, Hartsville, SC (US); Krishnaraju Varadarajan, Florence, SC (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Sonoco Development, Inc.

(21) Appl. No.: 10/977,815

(22) Filed: Oct. 29, 2004

(51) Int. Cl. G03B 17/02

(52) U.S. Cl. 222/327; 222/386; 53/396

(57) ABSTRACT

A caulk cartridge and method of making same, employing a relatively inexpensive barrier label in conjunction with a relatively inexpensive cartridge body. The barrier label has a non-foil barrier layer such as polymer film (e.g., PET or polypropylene) that is metallized, SiOx-coated, or AlOx-coated, and at least one heat seal layer forming at least one of the opposite surfaces of the label. The label is wrapped convolutely about the cartridge body and its opposite edges are overlapped and heat sealed together via the at least one heat seal layer.

### BACKGROUND OF THE INVENTION

The invention relates to caulk cartridges, and particularly relates to caulk cartridges formed principally of polymer materials.

Traditionally, caulk cartridges have been formed from wound paperboard tubes having an impervious liner and an outer label. The liner for high-barrier applications requiring a very low oxygen transmission rate (OTR) as well as low water vapor transmission rate (WVTR) typically comprises an aluminum foil laminate.

More recently, plastic caulk cartridges have been developed. While plastic cartridges have very low WVTR, many tend to have a high OTR and hence cannot be used in applications requiring a high oxygen barrier. Heretofore, to improve the oxygen barrier performance of plastic cartridges, one approach has been to coextrude a cartridge body as a two-layer structure including an inner layer of material such as EVOH that provides a high oxygen barrier but is relatively expensive, and an outer layer of material (such as polyethylene) that is a poorer oxygen barrier but is considerably less expensive. Because of the high cost of the high-barrier material and the complexity and high cost of the coextrusion equipment and process, cartridges made in this manner tend to be quite expensive such that they cannot effectively compete with paperboard caulk tubes.

### BRIEF SUMMARY OF THE INVENTION

The invention addresses the above needs and achieves other advantages, by providing a caulk cartridge and method of making same, employing a relatively inexpensive barrier label in conjunction with a relatively inexpensive cartridge body. More specifically, the barrier label has a non-foil barrier layer such as polymer film (e.g., PET or polypropylene) that is metallized, SiOₓ-coated, or AlOₓ-coated, and at least one heat seal layer forming at least one of the opposite surfaces of the label. The label is wrapped convolutely about the cartridge body and its opposite edges are overlapped and heat sealed together via the at least one heat seal layer.

In one embodiment, the label has only one heat seal layer; the opposite surface of the label from the heat seal layer can be formed by the barrier layer or by another layer such as a paper backing layer laminated to the barrier layer. To heat seal the label edges together, one edge is folded inwardly to place the heat seal layer on the folded edge in contact with the heat seal layer on the opposite (non-folded) edge.

In a preferred embodiment, the label has two heat seal layers forming both opposite surfaces of the label. In this embodiment, the label edges form a simple lap seam (i.e., with no fold). One preferred label structure comprises a barrier layer of metallized polymer film sandwiched between two heat seal layers.

The invention also encompasses a method for making a cartridge body. The method entails extruding a continuous tubular cartridge body of polymer composition (e.g., polyethylene), and as the cartridge body advances downstream of the extruder, a continuous web of barrier label is advanced alongside the cartridge body and is wrapped convolutely about the body, and the opposite edges of the label are overlapped in suitable lap or fold seam fashion depending on the label structure. A continuous heat seal process then heat seals the overlapped edges together. The cartridge body with applied label can then be advanced to a cutting station where the body is cut into discrete lengths for formation into caulk cartridges. The method can also include the step of printing the outer surface of the label with graphics and indicia. The printing can be accomplished prior to the step of advancing the label to the cartridge body and wrapping the label about the body; alternatively, the printing can be accomplished after the body with applied label has been cut into discrete lengths.

A caulk cartridge in accordance with the invention can include a nozzle affixed to one end of the cartridge body in suitable fashion, such as by spin-welding. The opposite end of the body is closed by an axially slidable plunger that engages the inner surface of the cartridge body.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a caulk cartridge in accordance with one embodiment of the invention;

FIG. 2 is a schematic depiction of an apparatus and process for making a caulk tube in accordance with one embodiment of the invention;

FIG. 3 is a cross-sectional view through the high-barrier label in accordance with one embodiment of the invention;

FIG. 4 is a cross-sectional view through the caulk tube taken on line 4-4 in FIG. 2, showing one embodiment of the invention;

FIG. 5 is a cross-sectional view similar to FIG. 3, showing a high-barrier label in accordance with another embodiment of the invention;

FIG. 6 is a cross-sectional view through a caulk tube in accordance with a further embodiment of the invention; and

FIG. 7 is a cross-sectional view showing a high-barrier label in accordance with still another embodiment of the invention.

### DETAILED DESCRIPTION OF THE INVENTION

The present inventions now will be described more fully hereinafter with reference to the accompanying drawings, in which some but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

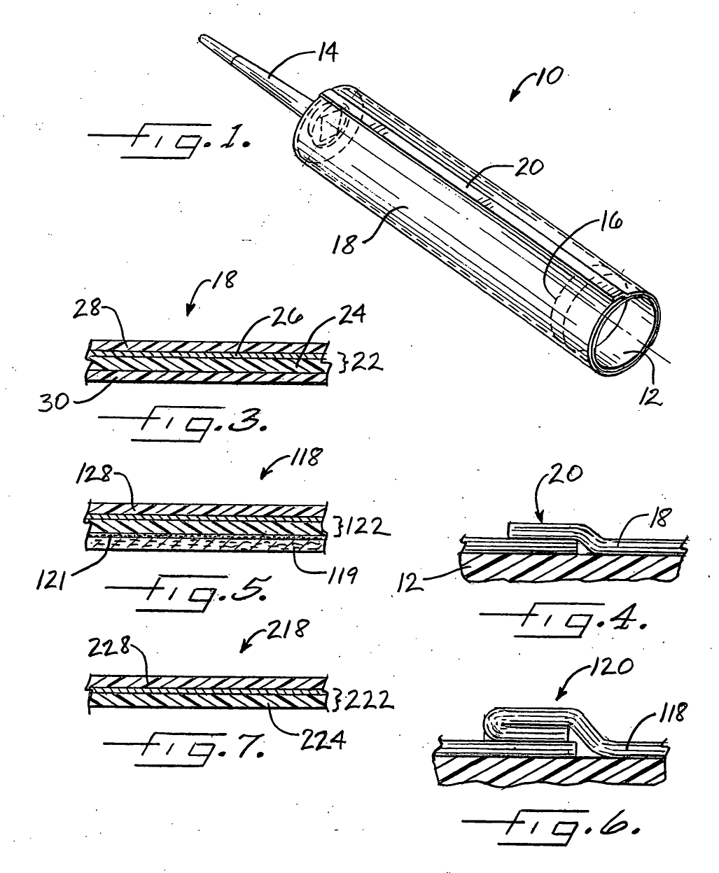

With reference to FIG. 1, a caulk tube 10 in accordance with one embodiment of the invention is shown. The caulk tube is formed of a tubular body 12, a nozzle 14 joined to one end of the tubular body 12, and an axially sliding plunger 16 that slidably engages the inner surface of the tubular body 12 in a sealed manner and is urged by a suitable mechanism (e.g., an axially movable piston rod of a caulk gun) toward the nozzle 14 to force the fluid contents of the tubular body out through the nozzle. The tubular body 12 comprises a polymer material and can be formed by any suitable process including extrusion or injection molding. When formed by extrusion, the tubular body 12 is made separated from the nozzle 14 and is subsequently joined to the nozzle, which preferably comprises a polymer material. For example, the tubular body and nozzle can be formed of a thermoplastic material such as polyethylene and the nozzle can be spin-welded to the tubular body. Alternatively, the tubular body and nozzle can be formed in one piece by injection molding.

The caulk tube 10 also includes a high-barrier label 18 wrapped tightly about the outer surface of the tubular body 12 in a convolute fashion. Alternatively, the label 18 could be spirally wrapped about the body. The opposite longitudinal edges of the label form an overlap joint 20 and are sealed together. The label comprises a multi-layer structure including at least one barrier layer providing a barrier against transmission of oxygen, and at least one sealant layer for sealing the edges of the label together, as further described below with reference to particular embodiments of the label.

Thus, FIG. 3 shows a cross-sectional view through a label 18 in accordance with a first embodiment of the invention. The label includes a barrier layer 22 of metallized film comprising a polymer film 24 having a very thin vapor-deposited layer 26 of substantially pure metal such as aluminum. The polymer film 24 can comprise various materials including polyester such as polyethylene terephthalate, polypropylene, oriented polypropylene, and the like. The label further includes a pair of sealant layers 28 and 30 on opposite sides of the barrier layer and forming the opposite surfaces of the label. The sealant layers comprise a polymer material that is heat-sealable. Examples of suitable heat-sealable materials include polyethylene, polypropylene, ionomer resins such as SURLYN®, ethylene-methyl acrylate copolymer, and the like.

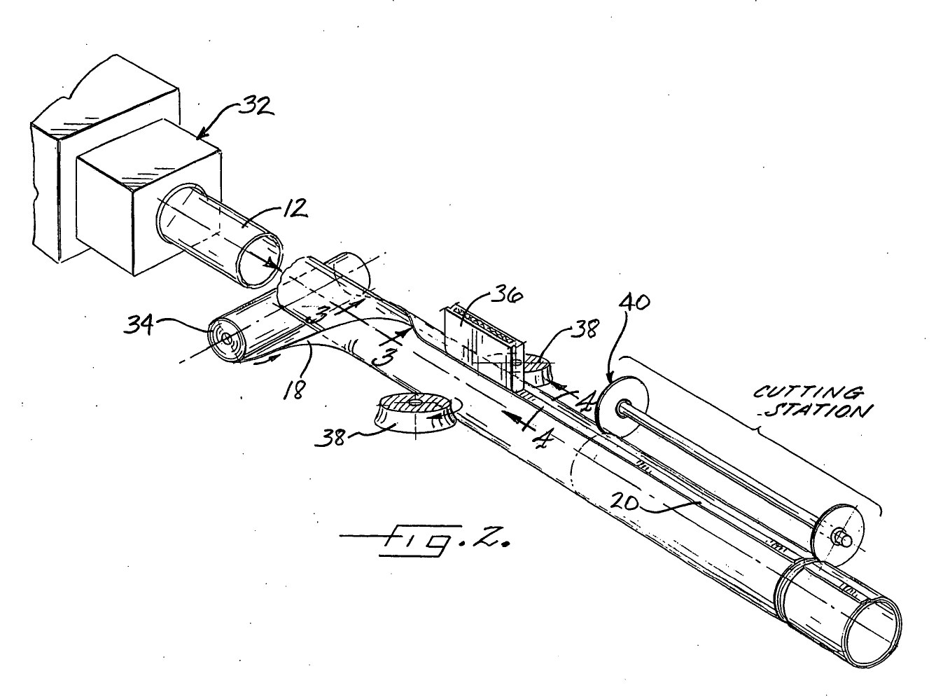

With a label having heat seal layers on its opposite surfaces, such as the illustrated label 18, the overlap joint of the label can be a simple lap joint as depicted in FIG. 4. The sealant layer 30 on one edge portion of the label is sealed to the sealant layer 28 on the opposite overlapping edge portion of the label.

An advantageous process for forming caulk tubes in accordance with certain embodiments of the invention is illustrated in FIG. 2. A plastic tubular body 12 is continuously extruded from an extruder 32. A high-barrier label 18 is drawn from a supply roll 34 and is wrapped in convolute fashion about the advancing continuous body 12. The width of the label 18 is slightly in excess of the circumference of the body 12. Opposite edges of the label are overlapped and a heat seal bar 36 heats the overlap joint 20 to seal the overlapping edges together. A pair of friction rollers 38 or the like engage the tubular body and label and are rotatably driven by a suitable motor (not shown) to advance the assembly in the axial direction of the tubular body. At a downstream station, a cutting device 40 cuts the tubular body into desired lengths for making caulk tubes. The process is thus continuous and highly efficient.

The discrete lengths of the tubular body 12 with applied label 18 can be subjected to a further downstream printing operation (not shown) for printing graphics and indicia on the exterior of the label, if desired. The tubular bodies can then be assembled with nozzles 14, filled with product, and closed by applying plungers 16.

As noted, various label structures can be used in accordance with the invention. An alternative label 118 in accordance with another embodiment of the invention is shown in FIG. 5. The label 118 comprises a paper backing layer 119 adhered by an adhesive layer 121 to one side of a metallized film barrier layer 122. The opposite side of the barrier layer is covered by a sealant layer 128. The metallized film 122 and the sealant layer 128 can comprise any of the materials noted above in connection with the metallized film 22 and sealant layer 28 of the previously described embodiment. Because of the presence of the paper backing layer 119, the label 118 must be sealed by a fold seal 120 as shown in FIG. 6. To make the fold seal, one edge of the label is folded inwardly and overlapped with the opposite unfolded edge of the label, so that the sealant layer of the folded edge is placed in contact with the sealant layer of the unfolded edge, and the edges are sealed together via the sealant layer.

FIG. 7 shows a label 218 in accordance with still another embodiment of the invention. The label 218 includes a metallized film barrier layer 222 covered on its outer surface by a sealant layer 228. The polymer film 224 of the barrier layer potentially could be the same as or at least compatible with the sealant layer 228 so that a simple lap joint could be formed generally as shown in FIG. 4 by heat sealing the film 224 on one edge to the sealant layer 228 on the opposite edge. Alternatively, where the film 224 is not heat-sealable, a fold seal as in FIG. 6 can be made.

The tubular body 12 of a caulk tube in accordance with the invention advantageously need not provide oxygen barrier performance because the label 18 provides adequate oxygen barrier performance. The tubular body can, and preferably does, provide moisture barrier performance. Accordingly, the tubular body can be formed of relatively inexpensive materials such as polyethylene (e.g., high-density polyethylene), polypropylene, or the like, and can be a simple one-layer extrusion rather than a more complex and expensive multi-layer coextrusion.

The illustrated embodiments in FIGS. 3, 5, and 7 all include a metallized film as the non-foil barrier layer. Alternatively, however, other types of non-foil barrier layers can be employed, including but not limited to films of ethylene vinyl alcohol copolymer (EVOH), polyvinylidene chloride (PVDC), polyamide (nylon), and the like, or films coated with silicon oxide (SiOₓ) or aluminum oxide (AlOₓ) materials (thus, for example, layer 26 in FIG. 3 can represent either a metallization layer, a SiOₓ layer, or an AlOₓ layer). More than one barrier layer, of the same or different types, can be included in a label in accordance with the invention, if required to meet a particular barrier requirement.

Finally, it must be noted that the process of FIG. 2 has utility not only in the context of the application of a barrier label to an extruded tube, but can also be useful when the label is not relied upon for barrier performance but only for aesthetics.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A caulk cartridge, comprising:
a tubular cartridge body formed f a polymer composition providing moisture barrier performance, the cartridge body having an outer surface and an inner surface and having opposite first and second ends;
a nozzle affixed to the first end of the cartridge body;
an axially slidable plunger engaging the inner surface of the cartridge body to close the second end thereof; and
a barrier label wrapped about and covering substantially the entire outer surface of the cartridge body and having opposite edges overlapping and sealed together at a seam, the barrier label comprising a non-foil barrier layer providing oxygen barrier performance, and at least one heat seal layer forming at least one of the opposite surfaces of the barrier label, the seam of the barrier label being formed by heat sealing the opposite edges of the label together via the at least one heat seal layer.

2. The caulk cartridge of claim 1, wherein the non-foil barrier layer of the label comprises a polymer film having a barrier coating.

3. The caulk cartridge of claim 2, wherein the barrier coating is selected from the group consisting of a metallization layer, a SiOₓ coating, and an AlOₓ coating.

4. The caulk cartridge of claim 1, wherein the seam of the barrier label extends parallel to a longitudinal axis of the cartridge body.

5. The caulk cartridge of claim 1, wherein the barrier label comprises two heat seal layers respectively forming the opposite surfaces of the barrier label, and wherein the seam of the barrier label comprises a simple lap seam in which one of the heat seal layers on one of the edges of the label is heat sealed to the other heat seal layer on the other edge of the label.

6. The caulk cartridge of claim 1, wherein the barrier label comprises only one heat seal layer forming one of the opposite surfaces of the label, and wherein the seam of the barrier label comprises a fold seam in which one of the edges of the label is folded to place the heat seal layer on the one edge in contact with the heat seal layer on the other edge of the label whereupon the edges are heat sealed together.

7. The caulk cartridge of claim 6, wherein the barrier label includes a paper backing layer.

8. The caulk cartridge of claim 1, wherein the cartridge body comprises an ethylene polymer.

9. A caulk tube, comprising:
a tubular cartridge body formed of a polymer composition providing moisture barrier performance, the cartridge body having an outer surface and an inner surface and having opposite first and second ends; and
a barrier label wrapped about and covering substantially the entire outer surface of the cartridge body and having opposite edges overlapping and sealed together at a seam, the barrier label comprising a non-foil barrier layer providing oxygen barrier performance, and at least one heat seal layer forming at least one of the opposite surfaces of the barrier label, the seam of the barrier label being formed by heat sealing the opposite edges of the label together via the at least one heat seal layer.

10. The caulk tube of claim 9, wherein the non-foil barrier layer of the label comprises a polymer film having a barrier coating selected from the group consisting of a metallization layer, an SiOₓ coating, and an AlOₓ coating.

11. The caulk tube of claim 9, wherein the seam of the barrier label extends parallel to a longitudinal axis of the cartridge body.

12. The caulk tube of claim 9, wherein the barrier label comprises two heat seal layers respectively forming the opposite surfaces of the barrier label, and wherein the seam of the barrier label comprises a simple lap seam in which one of the heat seal layers on one of the edges of the label is heat sealed to the other heat seal layer on the other edge of the label.

13. The caulk tube of claim 9, wherein the barrier label comprises only one heat seal layer forming one of the opposite surfaces of the label, and wherein the seam of the barrier label comprises a fold seam in which one of the edges of the label is folded to place the heat seal layer on the one edge in contact with the heat seal layer on the other edge of the label whereupon the edges are heat sealed together.

14. The caulk tube of claim 13, wherein the barrier label includes a paper backing layer.

15. The caulk tube of claim 9, wherein the cartridge body comprises an ethylene polymer.

16. A method for making a caulk tube, comprising the steps of:
continuously extruding a tubular cartridge body of a polymer composition, the cartridge body advancing longitudinally along a path;
advancing a continuous web of label alongside the advancing cartridge body and wrapping the label about an outer surface of the cartridge body with a width of the label extending circumferentially about the cartridge body; and
overlapping opposite edges of the label and sealing the overlapping edges together to form a seam that extends parallel to a longitudinal axis of the cartridge body.

17. The method of claim 16, wherein the label includes at least one heat seal layer forming at least one of the opposite surfaces of the label, and the sealing step comprises heat sealing the overlapping edges of the label together via the at least one heat seal layer.

18. The method of claim 17, wherein the label includes only one heat seal layer forming one of the opposite surfaces of the label, and the overlapping step comprises folding one edge of the label and overlapping the folded edge with the opposite edge of the label to place the heat seal layer on the folded edge in contact with the heat seal layer on the opposite edge.

19. The method of claim 17, wherein the label includes two heat seal layers respectively forming both of the opposite surfaces of the label, and the overlapping step comprises placing one of the heat seal layers on one edge of the label in contact with the other heat seal layer on the opposite edge of the label.

20. The method of claim 16, further comprising the steps of advancing the cartridge body having the label wrapped and heat sealed thereabout to a cutting station, and operating a cutting device at the cutting station to cut the cartridge body into discrete lengths.

21. The method of claim 16, further comprising the step of printing indicia and graphics on an outer surface of the label.

22. The method of claim 16, further comprising the step of drawing the continuous web of label from a supply roll.

23. The method of claim 16, wherein the advancing step comprises advancing the label parallel to and at the same speed as the advancing cartridge body.
